(19) United States
(12) Patent Application Publication
(10) Pub. No.: US 2004/0243526 A1
(43) Pub. Date: Dec. 2, 2004

(54) Parking meter

(76) Inventors: Agenor Krygler, Warschau (PL); Alicja Krygler, Warschau (PL)

Correspondence Address: Friedrich Kueffner, Suite 910, 317 Madison Avenue, New York, NY, 10017, US

(21) Appl. No.: 10/756,842

(22) Filed: Jan. 13, 2004

(30) Foreign Application Priority Data
May 26, 2003 (PL) P-360334

(51) Int. Cl. G07B 15/02; G06F 17/00

(52) U.S. Cl. 705/418

(57) ABSTRACT

In order to create a parking meter (100) with an input device for means of payment and with an indicating device for indicating a paid parking time as well as with a central control device (6) which makes possible an exact debit of the parking time effectively used, it is proposed that a return device is provided for the return payment of an amount of money corresponding to the non used parking time. Furthermore, a corresponding method is indicated.

### BACKGROUND OF THE INVENTION

This invention relates to a parking meter with an input device for means of payment and with an indicating device for indicating a paid parking time and with a central control device as well as a method for running a parking space which can be carried out with the parking meter.

It is known from the practise that parking spaces are run with parking meters of various types in order to achieve an economic gain by renting parking spaces for vehicles. This being, so-called parking meters are known. A coin is inserted into these parking meters in order to rent the parking space for a predetermined parking time. This is expensive since an own parking meter must be made available for each parking space.

From the EP 1326 218 A2, we know a central parking meter for running several parking spaces, whereby an indicating means on the parking meter is assigned to each parking space in order to make possible to a supervising person a central supervision of the still existing residual parking times or of already expired parking times without the supervision staff having to check each parking space separately.

Further parking meters according to the art are known among others from the U.S. Pat. No. 4,876,540, the DE 42 072 36, the DE 38 402 58, the DE 40 137 19, the DE 40 396 and the DE 41 140 35.

It has shown to be disadvantageous for the known parking meters that, for the parking meters for which the payment takes place in advance, often the parking action is terminated before the maximal parking time which has been already paid is reached so that there results a financial prejudice for the user of the parking space.

### SUMMARY OF THE INVENTION

Considering the statement above, the general aim of the invention is to create a parking meter which makes possible, on the one hand, an exact debit of the parking time effectively necessary and, on the other hand, which can be realized in a simple manner. Furthermore, a corresponding system for the running of a car park is to be indicated.

These aims are achieved by the characteristics indicated in the claims 1 and 6.

As central idea of this invention, the parking meter has a return device. This being, the residual time which is still available until the maximal possible parking time already paid in advance is reached is determined by the central control device. With this time, with the parking fees fixed for this parking space an amount of money is determined which corresponds to the still remaining time. The return device pays this amount of money back to the user of the parking meter who leaves the parking space with his vehicle prematurely so that only the effectively parked time is debited. Additionally, a visual indicating device is provided for with which an amount of money corresponding to the parking time which is no longer required but which has been paid is indicated, this amount being returned by the parking meter. This amount of money can be calculated by the control device by means of the table of fees left. Thus, the user is informed about the amount of money saved. Additionally, an acoustic rendering of the returned amount of money can also take place.

It is understood that a corresponding table of fees, in which the parking fees for time-periods of different length, is deposited in a corresponding storage unit of the central control unit of the parking meter. This being, these fees can also be changed as wished by the operator of the parking meter. The determination of the still remaining parking time which is not used can be implemented by the skilled in the art in the hardware and/or in the software of the central control unit, whereby the timing signal of a clock existing anyway in the central control unit which supervises the lapse of time is taken as a basis. From the residual parking time determined in this way and the values deposited in the table of fees, the parking fees to be returned can be calculated by a calculation unit.

The advantage of the invention consists in the fact that only the effectively used parking time is paid by the user since he gets back the amount which he had overpaid. Furthermore, in this way, the running of the car park is possible with only one single parking meter, preferably installed at a central location of the parking area. A further parking meter which reads for example a magnetic card at the exit of the car park is not necessary.

It is clear for the skilled in the art that indicating means can be provided on the parking meter which indicate for each of the parking spaces to run separately the still remaining residual parking time or an exceeding of the parking time so that the car park can be supervised by only one supervising person. The payment of the parking fees in advance can take place in any way, for example by inserting coins into the parking meter. The return of the parking fees which are not necessary can also take place in many ways. A parking time to be paid in advance can also be entered by the user over an appropriate input device, for example over a keyboard. Among others, the corresponding amount can be paid in cash, or a document can be issued, for example by a printing device, about a credit of the corresponding amount, whereby this credit can be paid off to the user of the parking meter. Preferably, the payment or the credit takes place as described below.

The central idea of the invention consists in an electronic system for charging fees for the parking of vehicles with a central control device. The central control device disposes of a first signal input for the interface of the paying card, a second input for an input system, in particular a keyboard, a third input for the signal of a time generator and a fourth input for the signal from a supply system. A first output is connected with an interface of the paying card. A second output is connected with a visual indication and a system for the transfer of voice information. A third output is connected with a system for sound transmission. The paying card has an input for the signal of the interface of the paying card and an output at the interface of the paying card. The method for charging parking fees for vehicles with the electronic system of the parking meter consists in two phases of the payment. The first phase begins with the transmission of a signal from the paying card via the interface of the paying card to the control unit which is transmitted after having been entered, for example via the keyboard. After verification and ascertaining by the control unit that money is still on the paying card, the transfer of a flat rate for the parking is made by the paying card via the interface of the paying card to the control unit. The control unit opens in an assigned memory an account in which the identification number of the paying card and the value of the fees paid are stored and sends corresponding signals to the visual indication, to the voice and sound output in order to make a corresponding communication to the user, for example about the fees paid and/or about a residual credit on the paying card. The account is correspondingly reduced in accordance with the timing signal of the time generator and with a table of fees which can be fixed in the time course. The second phase consists in the return of fees which have not been used. It begins with the transmission of a signal from a paying card which has been also inserted into the parking meter via the interface of the paying card to the control unit. When the identification code of the paying card coincides with the code of an account opened in the control unit and when there is still a residual amount on this account, a corresponding signal is transmitted by the control unit via the interface to the paying card. Accordingly, a tellback of the fees which are not used is carried out via the interface to the paying card. Furthermore, it is provided that the state of the account on the paying card is indicated on the indicating device, whereby the amount of the fees to be paid back is also indicated on the indicating device. The credit which is now increased on the paying card can also be indicated. The parking meter does not require any technical maintenance since it can be operated with an appropriately dimensioned battery independently from the mains supply.

Advantageous configurations of the invention are characterized in the subclaims.

A cashless payment transaction is made possible with the configuration indicated in claim 2 and in claim 7. The corresponding read-write units for chip cards or the debit and credit of amounts of money on these chip cards are known from the prior art and the equipment of a parking meter with such a read-write unit is possible for the skilled in the art. All the means known by the skilled in the art for cashless transactions are to be understood by the term chip card. This being, the user inserts his chip card into the read-write unit and an amount of money which corresponds to the parking duration wished by the user is debited from the chip card and is booked in a storage unit of the central control device. If the user terminates early the parking action, the chip card is inserted again into the read-write unit and an amount of money which corresponds to the remaining parking duration which is not necessary is booked back to the chip card and the user is informed by a visual indication. The chip card can be an usual EC card or a paying card which is charged by the user with the amounts of money which he wishes. This offers the advantage that no money store for coins or bank notes exists in the parking meter so that there is no risk for the parking meter to be forced.

With the measure indicated in claim 3 and in claim 8, it is achieved that the fees effectively entitled to each user are returned and that a misuse is avoided. This being, the codification of the chip card or of a credit account in a storage unit of the control device can take place either via a PIN code which is entered by the user or in that the central control device reads the identification number which is unique for each chip card from this chip card in such a way that, in case of an early termination of the parking action, thus when a chip card is inserted again into the read-write unit, it detects again the identification number of the chip card. The credit account in the control device is then checked by means of this identification number to see if there is still an amount of money which has not been used. It is also possible that the codification takes place by the indication or the selection by the user of a parking space for which parking fees should be paid or returned.

According to claims 4 and 9, the user of the parking space can select a parking time which he would like to pay in advance via a selection device. It is also possible that he calls on the parking meter the parking space on which he parked his vehicle. To this purpose, a selection device configured at will can be provided on the parking meter. Preferably, this is a keyboard with which he selects a parking time or a parking space. Several key-buttons or push-buttons placed on a control panel can be provided on the parking meter in order to select the desired parking times or the parking space. This can also be realized in connection with a visual indicating device through an interactive menu control.

A battery actuated parking meter, as it is characterized in the claims 5 and 10, offers the advantage that it can be operated independently from the public supply mains so that the parking meter can also be used for running a car park which is situated, for example, outside a settlement area. It is possible for the skilled in the art to reduce the current consumption of the parking meter or to provide for a battery with a sufficient capacity so that a replacement or recharging of the battery is necessary only every three years. Thus, together with the cashless payment transactions, a low maintenance parking meter is obtained which does not need any further supervision or maintenance.

### BRIEF DESCRIPTION OF THE DRAWINGS

An embodiment of the invention is explained in detail below with reference to the attached drawings.

FIG. 1 shows a schematic view of a parking meter with a logic diagram and a front plate.

FIG. 2 shows the front plate according to FIG. 1.

FIG. 3 shows the logic diagram according to FIG. 1

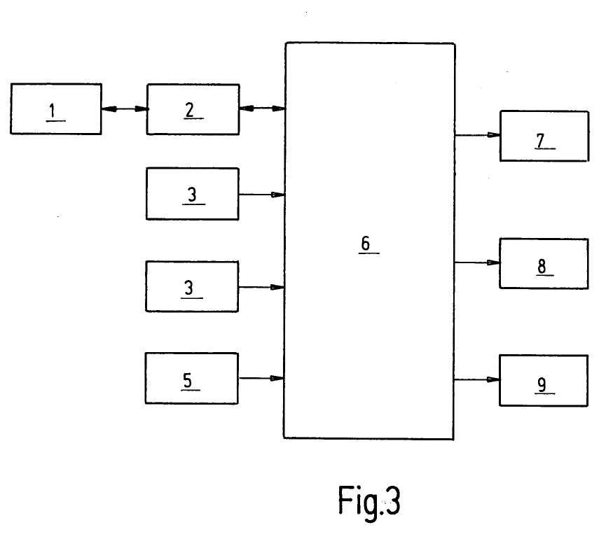

### DESCRIPTION OF THE PREFERRED EMBODIMENTS

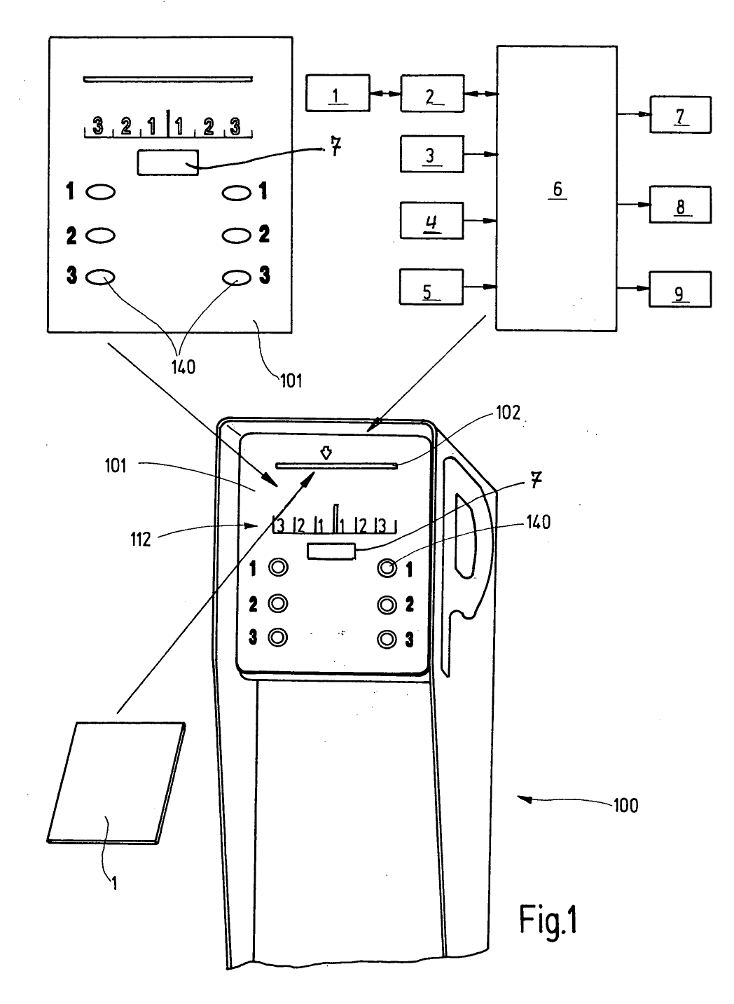

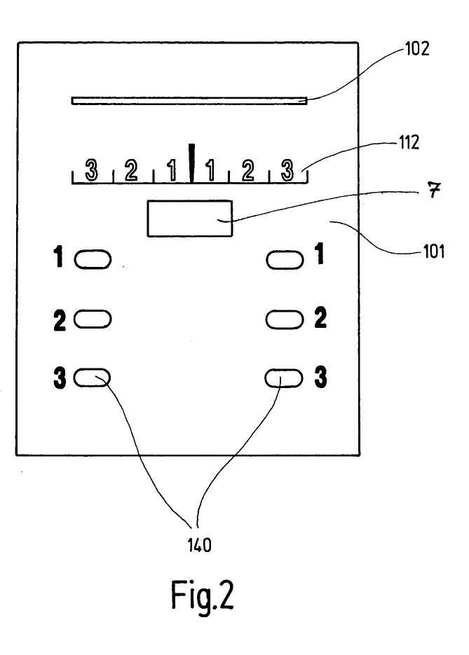

A section of a parking meter 100 according to the invention, as it is provided for the use in the practise, is shown on FIG. 1. The input and output system, the electronics and a central control device 6 of the parking meter 100 configured for example in form of a column are placed at the upper end of a pillar. They comprise (see also FIG. 2) a front plate 101 with an insertion slot 102 for a chip card 1, a ground plan 112 of the parking spaces as well as actuating means 140, for example in form of keys made of a clear material with integrated luminescent diodes which are assigned to the different parking spaces. The actuating means 140 can comprise mechanically acting microswitches which are mounted together with the integrated luminescent diodes directly on a printed card mounted behind the front plate 101. Sensors can also be used instead of mechanical means. With the integrated luminescent diodes per parking space, all the time segments of a parking action can be indicated.

From the representation in FIG. 1, the basic installation of the different components of the parking meter 100 can be seen. The parking meter 100 disposes of a central control unit 6 which is connected by a first input, as indicated by the arrows, with an interface 2 for a chip card 1. The arrows illustrate in which direction an information flows from a component to the other. The double arrow between the read-write unit 2 and the control device 6 indicates this for the case of a return payment onto the chip card 1. Furthermore, a selection device 3, preferably a keyboard, a time generator 4 as well as a current supply, in particular a battery, are provided for. The output of signals or information by the central control device 6 takes place over a visual indicating means 7, for example a current saving LCD display, and acoustical indicating means 8 and 9, for example a voice generator which emits stored voice information or a buzzer. Parking fees which have not been yet used are indicated when being returned by the visual indicating means.

For paying a wished parking time, the chip card 1 is inserted into the read-write unit 2 and is checked by this unit. Then, an amount of money which corresponds to the wished parking time, for example two hours, is debited by the central control device 6. The wished parking time can be selected by the user of the parking meter 100 by the selection device 3. The control device 6 then opens an individual account in a memory assigned to it. The debited amount is stored in the memory under the identification number of the chip card 1 or under the PIN number entered by the user which has been dectected by the read-write unit 2. Furthermore, corresponding information, in particular the paid parking time or the end of this parking time, is output by the control device 6 by visual and/or acoustical indicating means 7, 8, 9. A time generator 4, for example a quartz clock integrated in the parking meter, serves for the time control and supervision of the expiration of paid parking time.

It is also possible to enter a PIN number with which the chip card 1 is coded into the parking meter 100 via the selection device 3, for example a keyboard, in order to prevent an unauthorized use of a chip card 1 or to identify exactly the parking space paid with this chip card 1.

Preferably, no parking ticket which is for example deposited behind the windscreen of a vehicle is issued by the parking meter 100 but the remaining residual parking time is indicated directly by any indicating means 7, 8, 9 on the parking meter 100.

It is understood that the fees due per time unit for the rental of a parking space can be scaled linearly or progressively or regressively depending on the location and on the economic attractivity of the parking space. These fees which are respectively due per time unit, can also be entered or changed individually by the operator of the parking meter 100.

If the parking action is terminated before the maximal parking time already paid is reached, the chip card 1 is inserted again by the user into the read-write unit 2 and eventually an identification of the chip card 1 is made again, for example by the selection device 3. Then, the control device 6 checks if there is still a residual amount which corresponds to a parking duration which has not yet expired in the account or credit described above. If it is the case, the read-write unit 2 is triggered by the control device 6 in such a way that this amount is returned onto the chip card 1. This being, corresponding information is given by the visual indicating means 7. Additionally, an acoustical output of the fees to be returned can take place with the acoustical indicating means 8, 9.

The electronic system of the parking meter for charging fees for the parking of vehicles consists in a central control device 6 with an interface 2, for example in form of a read-write unit for a chip card, a selection device 3 for example in form of a keyboard, a time generator 4 and a current supply 5. Furthermore, a visual indicating means 7 as well as a voice output device 8 and a signal sound output device 9 are provided. The paying card 1, for example a chip card, disposes of an input for the interface 2 as well as of a corresponding output.

The timing cycle with which the fees stored in the account and debited from the paying card is adjusted at will by the operator of the parking meter. Preferably a parking space on which a vehicle is parked is selected on the selection device 3 and is transmitted to the control device 6. This control device then checks whether there is a sufficient credit on the paying card and debits a flat amount from the paying card. Corresponding information can be given to the user by the visual indicating means 7 as well as by the acoustical indicating means 8, 9. The amount of an advance payment can also be increased by the user with the selection device 3. In order to terminate the parking action, the paying card is inserted again into the parking meter in order to make a connection with the interface 2, whereby the paying card is checked as to its identification code. The user can also be informed about this visually and/or acoustically. If the identification code of the paying card coincides with an account opened in the memory of the control device 6, the account is checked to see if there is still a credit. This credit which is also indicated visually and/or acoustically is then transferred back to the paying card accordingly via the interface 2 so that a return payment of not used parking fees takes place. Thus, an exact settlement of the effectively required parking time is achieved. Each paying card is provided with an identification code for this which makes possible an individualization. This code can consist either in an own codification system for the parking meter, or can be realized for example by a pin number in the art of an EC-card.

List of Reference Numerals

1 Chip card

2 Read-write unit for chip card

3 Selection device

4 Time generator

5 Current supply

6 Central control device

7 Visual indicating means

8 Acoustical indicating means

9 Acoustical indicating means

100 Parking meter

1. Parking meter (100) with an input device for means of payment and with an indicating device (7, 8, 9) for indicating a paid parking time and with a central control device (6), wherein
a return device is provided for the return payment of an amount of money corresponding to the parking time which has not been used and a visual indicating device (7) is provided for indicating an amount of money which has not been used:

2. Parking meter according to claim 1, wherein
the input device and the return device is a read-write unit (2) for a chip card (1).

3. Parking meter according to claim 2, wherein
a code can be assigned to the chip card (1).

4. Parking meter according to claim 1, wherein
a selection device (3) is provided for the selection of a parking time to be paid and/or of a parking space, in particular a keyboard.

5. Parking meter according to claim 1, wherein
it is provided with a battery.

6. Method for running a parking area, in particular with a parking meter according to claim 1, whereby a parking time is paid in advance to a parking meter via an input device, wherein,
if the parking time is terminated before expiration of the already paid parking time, the corresponding amount of money is returned by a return device and is reproduced by a visual indicating device (7).

7. Method according to claim 6, wherein
the payment and the return payment takes place with a chip card (1).

8. Method according to claim 7, wherein
a codification of the chip card (1) takes place.

9. Method according to claim 6, wherein
a parking time and/or a parking space is selected.

10. Method according to claim 6, wherein
the parking meter is operated with a battery.
